(19) United States
(12) Patent Application Publication
(10) Pub. No.: US 2024/0258009 A1
(43) Pub. Date: Aug. 1, 2024

(54) COIL COMPONENT

(71) Applicant: Murata Manufacturing Co., Ltd., Kyoto-fu (JP)

(72) Inventors: Shigeto YAMAMOTO, Nagaokakyo-shi (JP); Ryota HASHIMOTO, Nagaokakyo-shi (JP); Shingo NAKAMOTO, Nagaokakyo-shi (JP)

(73) Assignee: Murata Manufacturing Co., Ltd., Kyoto-fu (JP)

(21) Appl. No.: 18/420,249

(22) Filed: Jan. 23, 2024

(30) Foreign Application Priority Data
Jan. 30, 2023 (JP) 2023-011900

(51) Int. Cl. H01F 27/00; H01F 27/28; H01F 27/29; H01F 27/30; H01F 41/069

(52) U.S. Cl. CPC H01F 27/006; H01F 27/2823; H01F 27/306; H01F 27/292; H01F 41/069

(57) ABSTRACT

A coil component configured such that if a certain turn of a second wire in the second layer is on a second end portion side of a turn of a first wire in the first layer of the same number as the certain turn, a direction of a positional difference is defined as a positive direction, and if in an opposite case, a direction of a positional difference is defined as a negative direction, a coil component includes a positive-direction positional difference area having a positional difference in the positive direction between turns of the first and second wires and a negative-direction positional difference area having a positional difference in the negative direction between turns of the first and second wires. The turns of the second wire include non-contact turns with which any wire is not in contact from a first end portion side.

### CROSS-REFERENCE TO RELATED APPLICATION

This application claims benefit of priority to Japanese Patent Application No. 2023-011900, filed Jan. 30, 2023, the entire content of which is incorporated herein by reference.

### BACKGROUND

### Technical Field

The present disclosure relates to a coil component and more specifically to an improvement in the winding mode of wires in a wire-wound coil component having a structure in which two wires are wound so as to form a plurality of layers around a winding core portion.

### Background Art

In this specification, regarding a first wire and a second wire wound around a winding core portion, the n-th turn is referred to as “turn Tn” (n is a natural number).

Regarding a positional difference between the first wire and the second wire, for example, in the case in which there is a recess between turn Tn and turn Tn+1 of one wire and turn Tn of the other wire is fitted into the recess, the positional difference is defined as “0.5 turns”. In the case in which turn Tn+2 of the other wire is fitted into the recess between turn Tn and the (n+1)-th turn of the one wire, the positional difference is defined as “1.5 turns”. In the case in which turn Tn+3 of the other wire is fitted into the recess between turn Tn and the (n+1)-th turn of the one wire, the positional difference is defined as “2.5 turns”.

Regarding the direction of a positional difference between the first wire and the second wire, in the case in which a certain turn of the second wire is located on the terminal end side in the winding direction of the turn of the first wire of the same number as the certain turn, the direction of the positional difference is defined as a positive direction, and “+” is added in front of the number indicating the degree of the positional difference. In the opposite cases, the direction of the positional difference is defined as a negative direction, and “−” is added in front of the number indicating the degree of the positional difference.

When turns of a wire are counted, the turns may be counted from either of the first end portion or the second end portion of the winding core portion. It can be said that even if the turn numbers are counted reversely, the turns have essentially the same configuration.

In this specification, of the plurality of layers formed by the wires wound around the winding core portion, the layer closest to the peripheral surface of the winding core portion, in other words, the layer at least part of which is in contact with the peripheral surface of the winding core portion is referred to as the first layer. The layer of turns wound on the outer peripheral side of the first layer so as to be fitted into the recesses formed between adjacent turns of the wire located in the first layer is referred to as the second layer. The layer of turns wound on the outer peripheral side of the second layer so as to be fitted into the recesses formed between adjacent turns of the wire located in the second layer is referred to as the third layer. Note that the reason why the first layer, which is the layer closest to the peripheral surface of the winding core portion, is defined as the layer at least part of which is in contact with the peripheral surface of the winding core portion is that a wire is usually in contact with only the corner edge portions of a winding core portion having, for example, a polygonal cross section, without all of the length of the wire being in contact with the peripheral surface of the winding core portion, and the wire in the other portions is usually a little above the peripheral surface of the winding core portion. The second layer and the third layer are the names given based on the positional relationship relative to the first layer and the second layer. Hence, the second layer only means that it is located on the outer peripheral side of the first layer, and the third layer only means that it is located on the outer peripheral side of the second layer.

Typical examples of the coil component that the present disclosure is directed to include common-mode choke coils.

A common-mode choke coil related to the present disclosure is described in, for example, Japanese Patent No. 6327397. FIG. 8A is a cross-sectional view schematically illustrating a characteristic configuration of the winding state of two wires 51 and 52 included in a coil component 50 that functions as the common-mode choke coil described in Japanese Patent No. 6327397. FIG. 8A corresponds to FIG. 2, 7, or 8 in Japanese Patent No. 6327397. FIGS. 8B and 8C are for explaining problems described later.

In FIGS. 8A, 8B, and 8C, the cross sections illustrating the first wire 51 are hatched to clearly distinguish between the first wire 51 and the second wire 52. The first wire 51 and the second wire 52 are spirally wound around a winding core portion 53 in the direction from a first end portion 54 to an opposed second end portion 55 of the winding core portion 53 to have substantially the same number of turns. The first wire 51 is wound so as to form the first layer in contact with the peripheral surface of the winding core portion 53, and most of the second wire 52 is wound so as to form the second layer outside of the first layer and to be fitted into the recesses formed between adjacent turns of the first wire 51.

The reason why what is wound to form the second layer outside of the first layer is expressed as most of the second wire 52 as described above is that some of the turns of the second wire 52, for example, turn Tm and turn Tm+1 are wound so as to be in contact with the peripheral surface of the winding core portion 53.

In FIGS. 8A, 8B, and 8C, each of the turns of the first wire 51 is connected to the corresponding one of the turns of the second wire 52 with a line segment. The turns connected by a line segment in this manner indicate that they are the turns of the same number counted from the first end portion 54.

The coil component 50 described in Japanese Patent No. 6327397 has been developed to aim at reducing the level of the mode conversion characteristics of a common-mode choke coil, and the embodiment illustrated in FIG. 8A has the following features.

Specifically, when each of the turns of the first wire 51 and the second wire 52 is expressed as the turn number n counted from the first end portion 54, the coil component 50 includes (1) a +0.5-turn difference area 57 in which turn Tn of the second wire 52 is fitted into the recess between turn Tn and turn Tn+1 of the first wire 51, and accordingly a positional difference of 0.5 turns in the positive direction is caused between the first wire and the second wire, (2) a −1.5-turn difference area 58 in which turn Tn+2 of the second wire 52 is fitted into the recess between turn Tn and turn Tn+1 of the first wire 51, and accordingly a positional difference of 1.5 turns in the negative direction is caused between the first wire 51 and the second wire 52, and (3) a transition area 59 in which the above +0.5-turn difference area 57 is changed to the above −1.5-turn difference area 58.

The number of turns of the second wire 52 located in the above 0.5-turn difference area 57 is two times or more and five times or less (i.e., from two times to five times) the number of turns of the second wire 52 located in the above 1.5-turn difference area 58.

This configuration enables the capacitance between the first wire 51 and the second wire 52 to be balanced as the entire first and second wires 51 and 52, thereby reducing the influence of the stray capacitance between the first wire 51 and the second wire 52. Hence, for example, in the case of a common-mode choke coil, it is possible to reduce the level of the mode conversion characteristics.

### SUMMARY

In the winding state illustrated in FIG. 8A, with focus on the second wire 52, any wire is not in contact with the first end portion 54 side of turn T1 located at the starting end of the +0.5-turn difference area 57, and any wire is also not in contact with the first end portion 54 side of turn Tm+2 located near the terminal end of the transition area 59.

Hence, for example, turn T1 is likely to be shifted in the direction to the first end portion 54. Hence, as illustrated in FIG. 8B, turn T1 sometimes inadvertently steps down onto the peripheral surface of the winding core portion 53, in other words, turn T1, which needs to be in the second layer, is sometimes located in the first layer or shifted on the first layer side. Such an inadvertent step down can occur in the state of a finished product of the coil component 50. However, if an inadvertent step down occurs in the process of winding the second wire 52 in the direction from the first end portion 54 to the second end portion 55, positional deviations of the subsequent turns T2, T3, and so on occur sequentially. As a result, a +0.5-turn difference area is not formed in the difference area 57, and, for example, a −0.5-turn difference area 60 is formed.

In addition, turn Tm+2 is also likely to be shifted in the direction to the first end portion 54. As illustrated in FIG. 8C, turn Tm+2 sometimes goes over turn Tm+1 and falls between turn Tm and turn Tm+1. Although not illustrated in FIG. 8C, in the case in which the gap between turn Tm and turn Tm+1 is wider, turn Tm+2 sometimes inadvertently steps down onto the peripheral surface of the winding core portion 53. If the positional deviation of turn Tm+2 as above occurs in the process of winding the second wire 52 in the direction from the first end portion 54 to the second end portion 55, positional deviations of the subsequent turns Tm+3, Tm+4, and so on occur sequentially. As a result, a −1.5-turn difference area is not formed in the difference area 58, and a −2.5-turn difference area 61 is formed.

If positional deviations of a wire occur as illustrated in FIGS. 8B and 8C, the capacitance between the first wire 51 and the second wire 52 is sometimes deviated from the design value, causing a capacitance imbalance and degrading the mode conversion characteristics.

Problems on positional deviation of the same kind can occur not only in common-mode choke coils but also, for example, in a wire-wound chip transformer or the like which also includes a first wire and a second wire.

Hence, the present disclosure provides a coil component in which the influence of the stray capacitance between a first wire and a second wire is low, and in which deviation is less likely to occur in the positions of the wires wound so as to form a plurality of layers around a winding core portion.

The present disclosure is directed to a coil component including: a core including a winding core portion having a first end portion and a second end portion opposed to each other in an axis direction of the winding core portion; and a first wire and a second wire having a circular cross section with a diameter of D and spirally wound around the winding core portion in a direction from the first end portion to the second end portion to have substantially the same number of turns.

One of the first wire and the second wire includes a portion wound to form a first layer which is a layer closest to a peripheral surface of the winding core portion, and the other of the first wire and the second wire includes a portion wound to be fitted into recesses formed between adjacent turns of a wire or wires located in the first layer and to form a second layer which is a layer of turns on an outer peripheral side of the first layer.

Regarding positional relationship between turns of the wire located in the first layer and turns of a wire located in the second layer, when it is assumed that if a certain turn of the wire located in the second layer and having a number counted from the first end portion is located on a second end portion side of a turn of the wire located in the first layer and having the same number counted from the first end portion as the certain turn, a direction of a positional difference is defined as a positive direction, and if in an opposite case, a direction of a positional difference is defined as a negative direction, the coil component includes a positive-direction positional difference area having a positional difference in the positive direction between turns of the first wire and the second wire and a negative-direction positional difference area having a positional difference in the negative direction between turns of the first wire and the second wire.

The turns of the wire located in the second layer include non-contact turns with which any wire located in the second layer is not in contact at least from a first end portion side, and a gap between two adjacent turns of the wire or the wires located in the first layer and forming a recess into which at least one of the non-contact turns is fitted has a size of L defined by ⅕×D≤L≤(√3−1)×D when measured in the axis direction.

Note that the size L of a gap measured in the axis direction denotes the minimum dimension of the gap in the axis direction.

In the present disclosure, the gap between the two adjacent turns of the wire located in the first layer and forming the recess into which the non-contact turn, with which any wire is not in contact at least from the first end portion side, out of the turns of the wire located in the second layer is fitted has a size L defined by ⅕×D≤L≤(√3−1) ×D when measured in the axis direction. Thus, the non-contact turn of the wire located in the second layer is less likely to have a positional deviation.

Regarding the positional relationship between the turns of the wire located in the first layer and the turns of the wire located in the second layer, since the coil component includes a positive-direction positional difference area having a positional difference in the positive direction between turns of the first wire and the second wire and a negative-direction positional difference area having a positional difference in the negative direction between turns of the first wire and the second wire, it is possible to reduce the influence of the stray capacitance between the first wire and the second wire. Hence, for example, in the case of a common-mode choke coil, it is possible to reduce the level of the mode conversion characteristics.

### BRIEF DESCRIPTION OF THE DRAWINGS

FIG. 1 is an external view of a coil component according to a first embodiment of the present disclosure illustrating the face to be faced to a mounting substrate;

FIG. 2 schematically illustrates the winding state of a first wire and a second wire of the coil component illustrated in FIG. 1 and is a cross-sectional view of part of a winding core portion around which the first wire and the second wire are wound;

FIGS. 3A and 3B are enlarged views of portion corresponding to part of FIG. 2, for explaining characteristics of the present disclosure;

FIG. 4 is a schematic cross-sectional view of part of a winding core portion around which a first wire and a second wire are wound, in a coil component according to a second embodiment of the present disclosure;

FIG. 5 is a schematic cross-sectional view of part of a winding core portion around which a first wire and a second wire are wound, in a coil component according to a third embodiment of the present disclosure;

FIG. 6 is a schematic cross-sectional view of part of a winding core portion around which a first wire and a second wire are wound, in a coil component according to a fourth embodiment of the present disclosure;

FIG. 7 is a schematic cross-sectional view of part of a winding core portion around which a first wire and a second wire are wound, in a coil component according to a fifth embodiment of the present disclosure; and

FIGS. 8A, 8B, and 8C are cross-sectional views schematically illustrating the winding state of two wires included in the coil component described in Japanese Patent No. 6327397, FIG. 8A illustrates a characteristic configuration of the winding state of the two wires, and FIGS. 8B and 8C are for explaining problems.

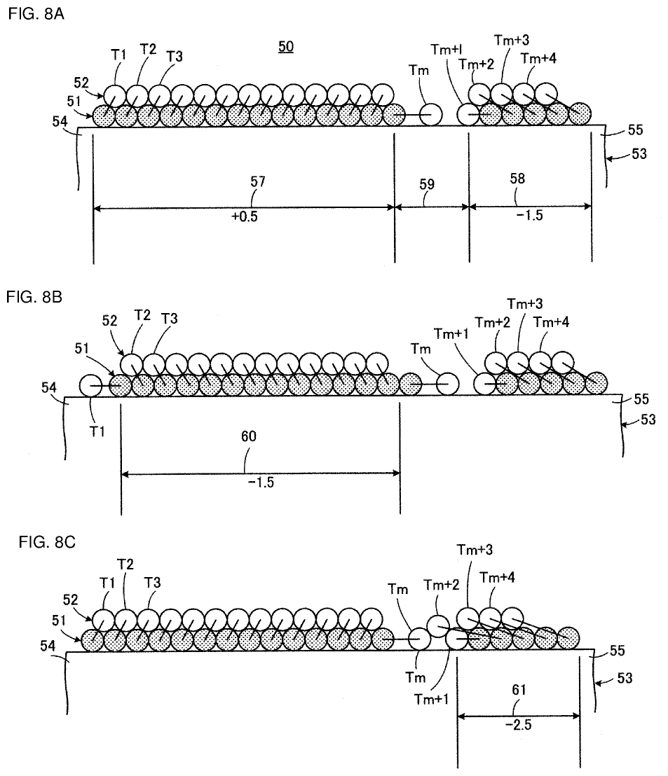

### DETAILED DESCRIPTION

### First Embodiment

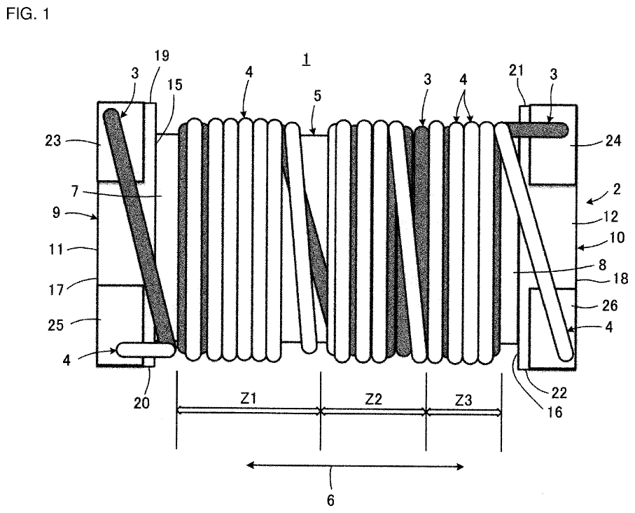

FIG. 1 is a view of a coil component 1 according to a first embodiment of the present disclosure, illustrating the face to be faced to a mounting substrate (not illustrated). The coil component 1 functions as a common-mode choke coil.

The coil component 1 includes a core 2 in a drum shape and a first wire 3 and a second wire 4 each serving as an inductor. The core 2 is made of a non-conductive material, more specifically, a ferrite of a Ni—Zn base or the like, a resin containing ferrite powder or metal magnetic powder, or a similar material.

The core 2 includes a winding core portion 5 and also includes a first flange portion 9 and a second flange portion 10 respectively protruding from a first end portion 7 and a second end portion 8, opposed to each other in the axis direction 6, of the winding core portion 5. The winding core portion 5 has a quadrangular cross section perpendicular to the axis direction 6. Note that the corner edge portions of the winding core portion 5 having a quadrangular cross section may be chamfered, and the cross-sectional shape of the winding core portion 5 may be another polygon such as a hexagon, a circle, an ellipse, or a shape formed by combining any of these as appropriate.

The first flange portion 9 and the second flange portion 10 have quadrangular prism shapes. The first flange portion 9 has a lower face 11 to be faced to a mounting substrate, a top face facing the side opposite to the lower face 11, an inner end face 15 at which the first end portion 7 of the winding core portion 5 is located, an outer end face 17 facing the side opposite to the inner end face 15 and thus facing outward, and a first side face 19 and a second side face 20 connecting the lower face 11 and the top face to each other and connecting the inner end face 15 and the outer end face 17 to each other. Similarly, the second flange portion 10 has a lower face 12 to be faced to the mounting substrate, a top face facing the side opposite to the lower face 12, an inner end face 16 at which the second end portion 8 of the winding core portion 5 is located, an outer end face 18 facing the side opposite to the inner end face 16 and thus facing outward, and a first side face 21 and a second side face 22 connecting the lower face 12 and the top face to each other and connecting the inner end face 16 and the outer end face 18 to each other. The corner edge portions of the first flange portion 9 and the second flange portion 10 may be chamfered.

The coil component includes four or more terminal electrodes. In this embodiment, the coil component 1 includes four terminal electrodes 23 to 26. The lower face 11 of the first flange portion 9 has the first terminal electrode 23 and the third terminal electrode 25, and the lower face 12 of the second flange portion 10 has the second terminal electrode 24 and the fourth terminal electrode 26. Although not illustrated, the first terminal electrode 23 and the third terminal electrode 25 may extend to portions of the outer end face 17 of the first flange portion 9, and the second terminal electrode 24 and the fourth terminal electrode 26 may 26 may extend to portions of the outer end face 18 of the second flange portion 10.

The terminal electrodes 23 to 26 are formed by, for example, applying a conductive paste containing silver as a conductive component onto the lower faces 11 and 12 and performing firing on the resultant, depositing silver onto the portions extending to the outer end faces 17 and 18, and then, plaiting copper, nickel, and tin in this order on these undercoating conductor films. Note that the terminal electrodes 23 to 26 may be provided by, for example, attaching metal terminals made of conductive metal plates onto the core 2 with an epoxy based adhesive agent.

The first wire 3 and the second wire 4 are spirally wound around the winding core portion 5. In FIG. 1, the first wire 3 is depicted as dark areas to clearly distinguish between the first wire 3 and the second wire 4. Details of the winding state of the first wire 3 and the second wire 4 will be described later. Each of the first wire 3 and the second wire 4 includes, for example, a line-shaped center conductor made of a highly conductive metal such as copper, silver, or gold, and the center conductor is covered with an electrically insulating coating of a resin such as polyurethane or polyamide-imide. The diameter of the line-shaped center conductor is not particularly limited. The numbers of turns of the first wire 3 and the second wire 4 are also not particularly limited. It is preferable that the diameters of the first wire 3 and the second wire 4 be 20 μm to 100 μm.

The end portions of the first wire 3 are connected to the first terminal electrode 23 and the second terminal electrode 24, and the end portions of the second wire 4 are connected to the third terminal electrode 25 and the fourth terminal electrode 26. These connections are made by, for example, heat pressure bonding.

Although not illustrated, the coil component 1 may further include a top plate extending over the top faces of the first flange portion 9 and the second flange portion 10. The top plate is for forming a closed magnetic path in cooperation with the core 2 and is made of a ferrite of the same kind as that of the material of the core 2, a non-conductive magnetic material other than ferrite, a resin containing ferrite powder or metal magnetic powder, or the like. The top plate is joined to the top face of the first flange portion 9 and the top face of the second flange portion 10 by using an adhesive. As the adhesive, a thermosetting epoxy resin or a composite magnetic resin composed of a thermosetting epoxy resin containing metal magnetic powder or ferrite powder with a particle diameter of 0.1 μm to 10 μm is preferably used. The adhesive may contain silica fillers or inorganic fillers such as inorganic magnetic powder to improve thermal shock resistance. Examples of methods of applying an adhesive include dipping the top face sides of the flange portions 9 and 10 of the core 2 into an adhesive and applying an adhesive to the surface of the top plate to be faced to the core 2 by dispensing or printing.

Note that a resin coating may be provided instead of the top plate. The top plate or coating is not essential.

The coil component 1 is manufactured, for example, as described below.

To manufacture the core 2, for example, ferrite powder is press-molded in a die, the resulting molded article is fired, and barrel polishing is performed on the resultant after firing to remove burrs.

Then, to provide the resulting core 2 with the terminal electrodes 23 to 26, an undercoating conductor film is formed on it, and after that, the resultant is subjected to barrel plating.

Next, the wires 3 and 4 are ejected from nozzles and wound around the winding core portion 5 of the core 2. The wires 3 and 4 are usually wound in different processes. Specifically, first, the first wire 3 is wound, and the end portions of the first wire 3 are joined to the first terminal electrode 23 and the second terminal electrode 24 by heat pressure bonding with a heater chip. Then, the second wire 4 is wound, and the end portions of the second wire 4 are joined to the third terminal electrode 25 and the fourth terminal electrode 26 by heat pressure bonding with a heater chip. Excesses of the wires 3 and 4 connected to the terminal electrodes 23 to 26 are cut and removed by a cutting blade. Note that the first wire 3 and the second wire 4 may be wound simultaneously.

After that, if necessary, the top plate is joined to the core 2 with an adhesive. With these processes, the coil component 1 is completed. Although the dimensions of the coil component 1 are not particularly limited, for example, the dimension in the axis direction 6 is 3.2 mm, the dimension in the width direction (the up-down direction in FIG. 1) is 2.5 mm, and the dimension in the height direction (the direction perpendicular to the drawing plane in FIG. 1) is 2.5 mm.

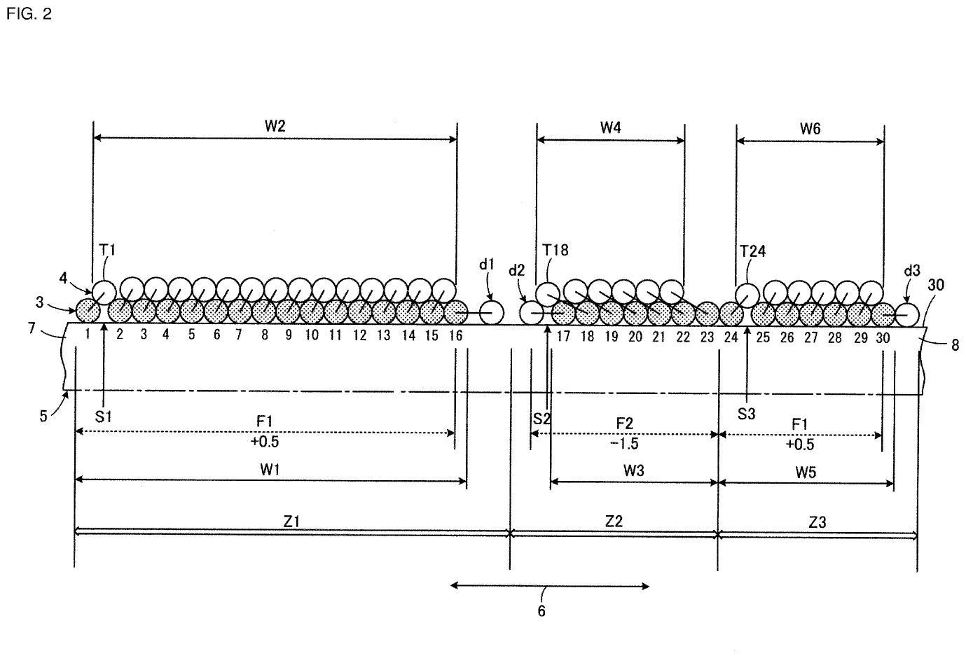

The winding state of the first wire 3 and the second wire 4 in the coil component 1 illustrated in FIG. 1 will be described mainly with reference to FIG. 2. FIG. 2 is a cross-sectional view of part of the winding core portion 5 around which the first wire 3 and the second wire 4 are wound.

In FIG. 2, the cross sections of the first wire 3 are hatched to clearly distinguish between the first wire 3 and the second wire 4. The first wire 3 and the second wire 4 are spirally wound around the winding core portion 5 so as to have substantially the same number of turns.

In FIG. 2, each of the turns of the first wire 3 is connected to the corresponding one of the turns of the second wire 4 with a line segment. The turns connected by a line segment in this manner indicate that they are the turns of the same number counted from the first end portion 7. The number is indicated under each turn of the first wire 3 located in the first layer. These numbers indicate the number of each turn of the wires 3 and 4. Thus, a certain turn of one of the wires 3 and 4 and the turn of the other of the wires 3 and 4 connected to the certain turn with a line segment indicate that they are turns of the number described above and turns of the same number. In the winding state illustrated in FIG. 2, each of the first wire 3 and the second wire 4 has turns T1 to T30. Note that FIG. 1 illustrates only part of the turns of the wires 3 and 4. Hence, the numbers of turns of the wires 3 and 4 differ between FIG. 1 and FIG. 2.

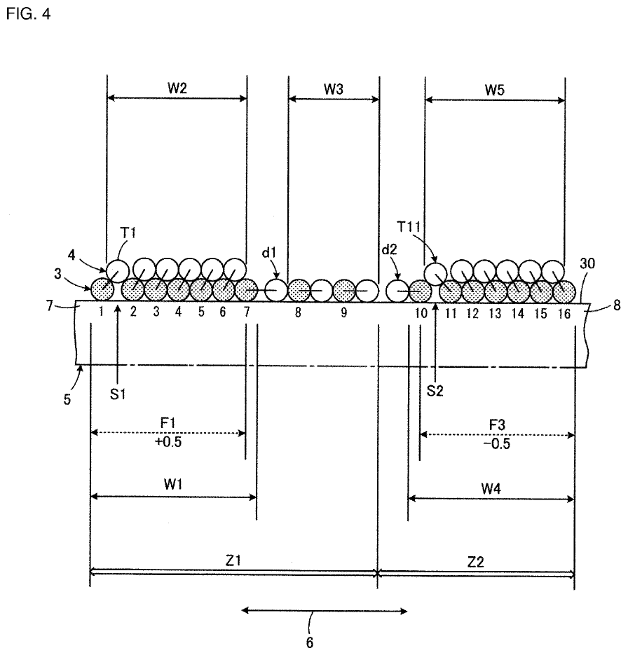

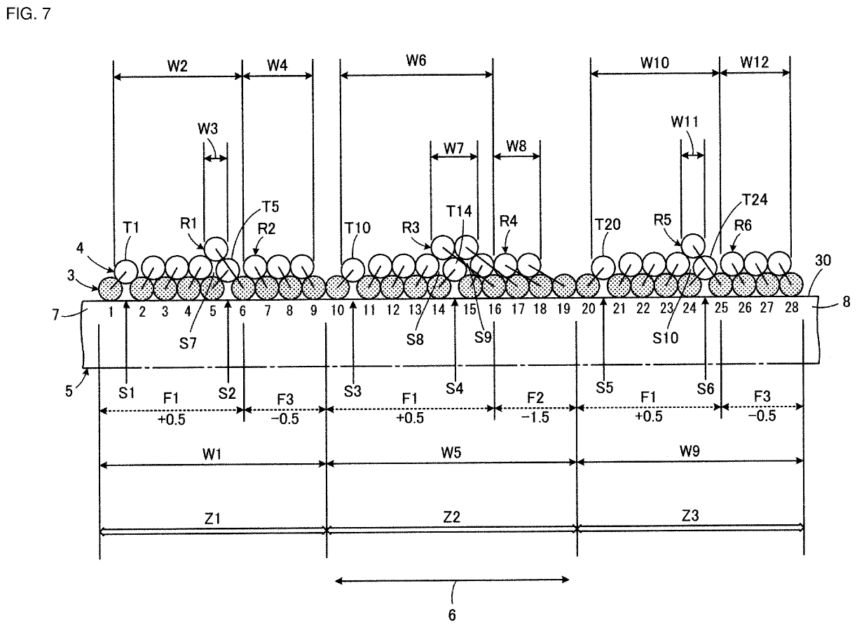

The above explanation about how FIG. 2 is illustrated applies to FIGS. 4 and 7 described later.

As described earlier, the first flange portion 9 and the second flange portion 10 have quadrangular prism shapes and have peripheral surfaces composed of the lower faces 11 and 12, the top faces, the first side faces 19 and 21, and the second side faces 20 and 22, respectively. The winding core portion 5 has a quadrangular cross section perpendicular to the axis direction 6, and the peripheral surface of the winding core portion 5 is composed of four faces. Hence, the four faces composing the peripheral surface of the winding core portion 5 and facing the same direction as the lower faces, the top faces, the first side faces, and the second side faces of the flange portions 9 and 10 are also respectively referred to as “lower face”, “top face”, “first side face”, and “second side face”.

FIG. 2 illustrates a top face 30 of the winding core portion 5 and the cross sections of the wires 3 and 4 on or above the top face 30.

With reference to FIG. 2, the first wire 3 and the second wire 4 are wound in a first winding area Z1, a second winding area Z2, and a third winding area Z3 that are arranged in the axis direction 6 of the winding core portion 5 and whose winding modes differ from one another.

The first winding area Z1 includes (1-1) a first winding portion W1 (turns T1 to T16) in which the first wire 3 is wound in the first layer in the direction from the first end portion 7 to the second end portion 8, (1-2) a second winding portion W2 (turns T1 to T15) in which the second wire 4 is wound in the second layer in the direction from the first end portion 7 to the second end portion 8, and (1-3) an intentional step-down portion d1 (turn T16) in which the second wire 4 is wound in the first layer on the second end portion 8 side of the first winding portion W1.

The second winding area Z2 includes (2-1) a third winding portion W3 (turns T17 to T23) in which the first wire 3 is wound in the first layer in the direction from the first end portion 7 to the second end portion 8, (2-2) an intentional step-down portion d2 (turn T17) in which the second wire 4 is wound in the first layer on the first end portion 7 side of the third winding portion W3, and (2-3) a fourth winding portion W4 (turns T18 to T23) in which the second wire 4 is wound in the second layer in the direction from the first end portion 7 to the second end portion 8.

The third winding area Z3 includes (3-1) a fifth winding portion W5 (turns T24 to T30) in which the first wire 3 is wound in the first layer in the direction from the first end portion 7 to the second end portion 8, (3-2) a sixth winding portion W6 (turns T24 to T29) in which the second wire 4 is wound in the second layer in the direction from the first end portion 7 to the second end portion 8, and (3-3) an intentional step-down portion d3 (turn T30) in which the second wire 4 is wound in the first layer on the second end portion 8 side of the fifth winding portion W5.

The first winding area Z1 includes a +0.5-turn difference area F1 having a positional difference of 0.5 turns in the positive direction between the first wire 3 and the second wire 4.

The second winding area Z2 includes a −1.5-turn difference area F2 having a positional difference of 1.5 turns in the negative direction between the first wire 3 and the second wire 4.

The third winding area Z3 includes a +0.5-turn difference area F1 having a positional difference of 0.5 turns in the positive direction between the first wire 3 and the second wire 4.

This configuration reduces the influence of the stray capacitance between the first wire 3 and the second wire 4 and, for example, reduces the level of the mode conversion characteristics in the case of a common-mode choke coil.

With focus on the wire located in the second layer, specifically, with focus on the second wire 4 in the case of this embodiment, the turns of the second wire 4 include non-contact turns T1, T18, and T24 with which any wire is not in contact at least from the first end portion 7 side. Regarding at least one of these non-contact turns T1, T18, and T24, in this embodiment, regarding all of the non-contact turns T1, T18, and T24, there is a gap S1, S2, or S3 between the two adjacent turns of the wire located in the first layer and forming the recess into which each of the non-contact turns T1, T18, and T24 is fitted.

More specifically, the recess into which the non-contact turn T1 of the second wire 4 is fitted is formed between turn T1 of the first wire 3 and turn T2 of the first wire 3, and turn T1 of the first wire 3 and turn T2 of the first wire 3 form the gap S1 in between.

The recess into which the non-contact turn T18 of the second wire 4 is fitted is formed between turn T17 of the second wire 4 and turn T17 of the first wire 3, and turn T17 of the second wire 4 and turn T17 of the first wire 3 form the gap S2 in between.

The recess into which the non-contact turn T24 of the second wire 4 is fitted is formed between turn T24 of the first wire 3 and turn T25 of the first wire 3, and turn T24 of the first wire 3 and turn T25 of the first wire 3 form the gap S3 in between.

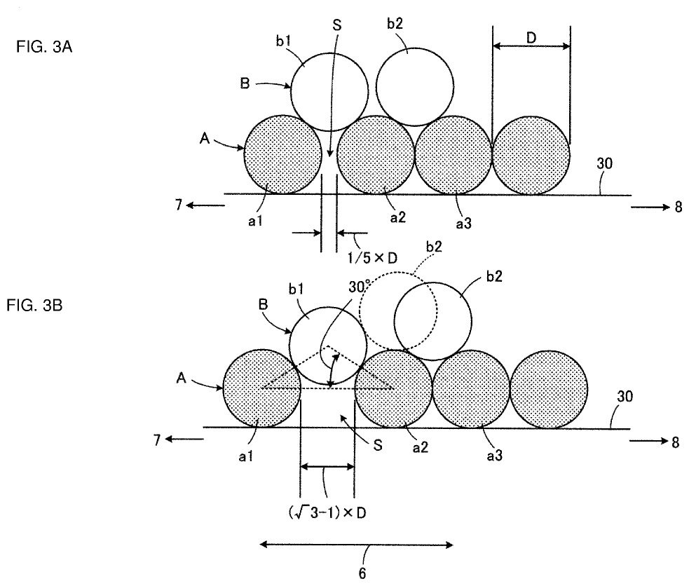

The size of each of the gaps S1, S2, and S3 will be described with reference to FIGS. 3A and 3B. FIGS. 3A and 3B illustrate the top face 30, which is part of the peripheral surface of the winding core portion 5, and also illustrates a wire A located in the first layer and a wire B located in the second layer. The wire A is hatched to clearly distinguish between the wire A and the wire B. Here, because it is not necessary to distinguish between the gaps S1, S2, and S3 for explanation, a common reference symbol “S” is used for a gap.

FIG. 3A illustrates the lower limit of the size of the gap S, and FIG. 3B illustrates the upper limit of the size of the gap S. In FIGS. 3A and 3B, the non-contact turn of the wire B is referred to as turn b1, and the two adjacent turns of the wire A forming the recess into which the non-contact turn b1 is fitted are referred to as turns a1 and a2. The diameter of the wires A and B is assumed to be D.

Regarding the lower limit of the size of the gap S illustrated in FIG. 3A, even if there is a gap S, if the gap S is small, there is a possibility that the non-contact turn b1 of the wire B cannot sit stably in the recess between turns a1 and a2 of the wire A and can inadvertently step down to the first end portion 7 side. In this regard, the following experiment was performed to determine the lower limit of the size of the gap S.

Coil components were produced as test samples, each coil component including a wire with a diameter D of 56 μm composed of a line-shaped center conductor made of copper and having a diameter of 40 μm, on which an electrically insulating coating with a film thickness of 8 μm is formed. As a result of an investigation of 1000 test samples about the relationship between the rate of occurrence of an inadvertent step down and the size of the gap S, an inadvertent step down occurred in 6% of the total number of the test samples. To be more specific, of 6% of the test samples that exhibited an inadvertent step down, 3% of the test samples exhibited an inadvertent step down in cases in which the size of the gap S measured in the axis direction 6 was less than 1/9×D, 2% of the test samples exhibited an inadvertent step down in cases in which the size of the gap S measured in the axis direction 6 was 1/9×D or more and 1/7×D or less (i.e., from 1/9×D to 1/7×D), 1% of the test samples exhibited an inadvertent step down in cases in which the size of the gap S measured in the axis direction 6 was 1/7×D or more and ⅕×D or less (i.e., from 1/7×D to ⅕×D), and no test sample exhibited an inadvertent step down in cases in which the size of the gap S measured in the axis direction 6 was ⅕×D or more.

From the above experiment results, the lower limit of the size of the gap S measured in the axis direction 6 was determined to be ⅕×D.

Next, the upper limit of the size of the gap S illustrated in FIG. 3B was determined as follows. Non-contact turn b1 of the wire B needs to sit stably in the recess between turns a1 and a2 of the wire A without inadvertently stepping down between turns a1 and a2 of the wire A and without turn b2 of the wire B not going over turn b1 to the first end portion 7 side. In this regard, as illustrated in FIG. 3B, the inventors of the present disclosure found that the appropriate upper limit of the size of the gap S between turn a1 and turn a2 is a gap S formed by drawing an isosceles triangle whose base is the line segment connecting the center of turn a1 and the center of turn a2 and whose base and hypotenuses form angles of 30 degrees, and placing turn a1 and turn a2 such that the center of turn b1 is positioned at the vertex of the isosceles triangle. Specifically, when the upper limit of the size of the gap S is (√3−1) ×D, even if turn b2 seeks to move in the direction to turn b1, turn b2 can move only to the position directly above turn a2 because of the presence of turn b1, as indicated with the dotted line in FIG. 3B. Thus, turn b2 cannot go over turn a2, and turn b2 is likely to sit between turn a2 and turn a3 where turn b2 is more stable.

As described above, the size L of the gap S measured in the axis direction 6 is defined as ⅕×D≤L≤(√3−1) ×D.

If this condition is satisfied, the non-contact turn b1 of the wire B located in the second layer is less likely to have a positional deviation. Hence, if at least one of the gaps S1, S2, and S3 illustrated in FIG. 2, or more preferably, all of the gaps S1, S2, and S3 satisfy the condition ⅕×D≤L≤(√3−1) ×D, the wire 4 located in the second layer will be less likely to have a positional deviation.

### Other Embodiments

With reference to FIGS. 4 to 7, other embodiments in which the first wire 3 and the second wire 4 are wound in a different winding state will be described. FIGS. 4 to 7 are figures corresponding to FIG. 2. In FIGS. 4 to 7, the elements corresponding to those illustrated in FIG. 2 are denoted by the same or similar reference symbols, and repetitive description thereof is omitted.

### Second Embodiment

In a second embodiment illustrated in FIG. 4, a first wire 3 and a second wire 4 are wound in a first winding area Z1 and a second winding area Z2 that are arranged in the axis direction 6 of the winding core portion 5 and whose winding modes differ from each other.

The first winding area Z1 includes (1-1) a first winding portion W1 (turns T1 to T17) in which the first wire 3 is wound in the first layer in the direction from the first end portion 7 to the second end portion 8, (1-2) a second winding portion W2 (turns T1 to T6) in which the second wire 4 is wound in the second layer in the direction from the first end portion 7 to the second end portion 8, (1-3) an intentional step-down portion d1 (turn T7) in which the second wire 4 is wound in the first layer on the second end portion 8 side of the first winding portion W1, and (1-4) a third winding portion W3 (turns T8 to T9) in which the first wire 3 and the second wire 4 are wound alternately in the axis direction 6 in the first layer on the second end portion 8 side of the first winding portion W1 in the direction from the first end portion 7 to the second end portion 8.

The second winding area Z2 includes (2-1) a fourth winding portion W4 (turns T10 to T16) in which the first wire 3 is wound in the first layer in the direction from the first end portion 7 to the second end portion 8, (2-2) an intentional step-down portion d2 (turn T10) in which the second wire 4 is wound in the first layer on the second end portion 8 side of the third winding portion W3, and (2-3) a fifth winding portion W5 (turns T11 to T16) in which the second wire 4 is wound in the second layer in the direction from the first end portion 7 to the second end portion 8.

The first winding area Z1 includes a +0.5-turn difference area F1 having a positional difference of 0.5 turns in the positive direction between the first wire 3 and the second wire 4.

The second winding area Z2 includes a −0.5-turn difference area F3 having a positional difference of 0.5 turns in the negative direction between the first wire 3 and the second wire 4.

This configuration reduces the influence of the stray capacitance between the first wire 3 and the second wire 4 and, for example, reduces the level of the mode conversion characteristics in the case of a common-mode choke coil.

The turns of the second wire 4 include non-contact turns T1 and T11 with which any wire is not in contact at least from the first end portion 7 side. A gap S1 is formed between turns T1 and T2 of the first wire 3 forming the recess into which the non-contact turn T1 of the second wire 4 is fitted, and a gap S2 is formed between turns T10 and T11 of the first wire 3 forming the recess into which the non-contact turn T11 of the second wire 4 is fitted.

Also in this embodiment, the gaps S1 and S2 have a size L defined by ⅕×D≤L ≤(√3−1) ×D when measured in the axis direction 6.

### Third Embodiment

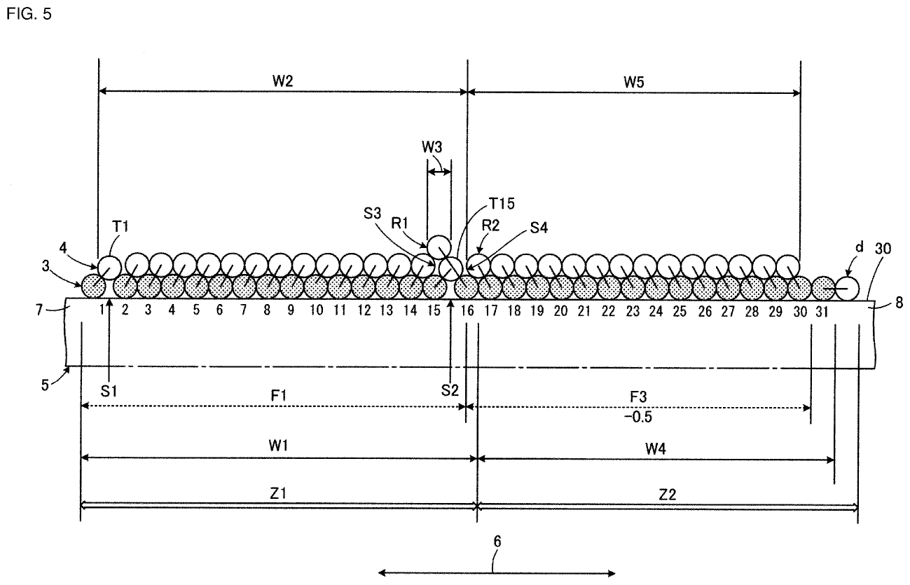

In a third embodiment illustrated in FIG. 5, a first wire 3 and a second wire 4 are wound in a first winding area Z1 and a second winding area Z2 that are arranged in the axis direction 6 of the winding core portion 5 and whose winding modes differ from each other.

The first winding area Z1 includes (1-1) a first winding portion W1 (turns T1 to T16) in which the first wire 3 is wound in the first layer in the direction from the first end portion 7 to the second end portion 8, (1-2) a second winding portion W2 (turns T1 to T15) in which the second wire 4 is wound in the second layer in the direction from the first end portion 7 to the second end portion 8, (1-3) a first transfer portion R1 (from turn T15 to turn T16) in which the direction of the second wire 4 is changed at the end portion of the second winding portion W2 on the second end portion 8 side to the direction to the first end portion 7, and the second wire 4 is lead to a position in the third layer, (1-4) a third winding portion W3 (turn T16) in which the second wire 4 continuous with the first transfer portion R1 is wound in the third layer, and (1-5) a second transfer portion R2 (from turn T16 to turn T17) in which the second wire 4 is lead from the third winding portion W3 to a position in the second layer.

The second winding area Z2 includes (2-1) a fourth winding portion W4 (turns T17 to T31) in which the first wire 3 is wound in the first layer in the direction from the first end portion 7 to the second end portion 8, (2-2) a fifth winding portion W5 (turns T17 to T30) in which the second wire 4 continuous with the second transfer portion R2 is wound in the second layer in the direction from the first end portion 7 to the second end portion 8, and (2-3) an intentional step-down portion d (turn T31) in which the second wire 4 is wound in the first layer on the second end portion 8 side of the fourth winding portion W4.

The first winding area Z1 includes a +0.5-turn difference area F1 having a positional difference of 0.5 turns in the positive direction between the first wire 3 and the second wire 4.

The second winding area Z2 includes a −0.5-turn difference area F3 having a positional difference of 0.5 turns in the negative direction between the first wire 3 and the second wire 4.

This configuration reduces the influence of the stray capacitance between the first wire 3 and the second wire 4 and, for example, reduces the level of the mode conversion characteristics in the case of a common-mode choke coil.

The turns of the second wire 4 include non-contact turns T1 and T15 with which any wire is not in contact at least from the first end portion 7 side. A gap S1 is formed between turns T1 and T2 of the first wire 3 forming the recess into which the non-contact turn T1 of the second wire 4 is fitted, and a gap S2 is formed between turns T15 and T16 of the first wire 3 forming the recess into which the non-contact turn T15 of the second wire 4 is fitted.

Also in this embodiment, the gaps S1 and S2 have a size L defined by ⅕×D≤L ≤(√3−1) ×D when measured in the axis direction 6.

Since turn T15 of the second wire 4 is fitted between turns T15 and T16 of the first wire 3 forming the gap S2 described above, it is natural that gaps S3 and S4 are formed on either side of turn T15 of the second wire 4. Turn T16 of the second wire 4 located in the third layer described above is fitted into the gap S3 and is thus less likely to have a positional deviation. The gaps S3 and S4 are a little narrower than the gaps S1 and S2.

Note that although not specifically described, gaps naturally formed by being derived from a gap formed between turns of a wire located in the first layer, as with the gaps S3 and S4, are also formed in the embodiment illustrated in FIGS. 2 and 4.

### Fourth Embodiment

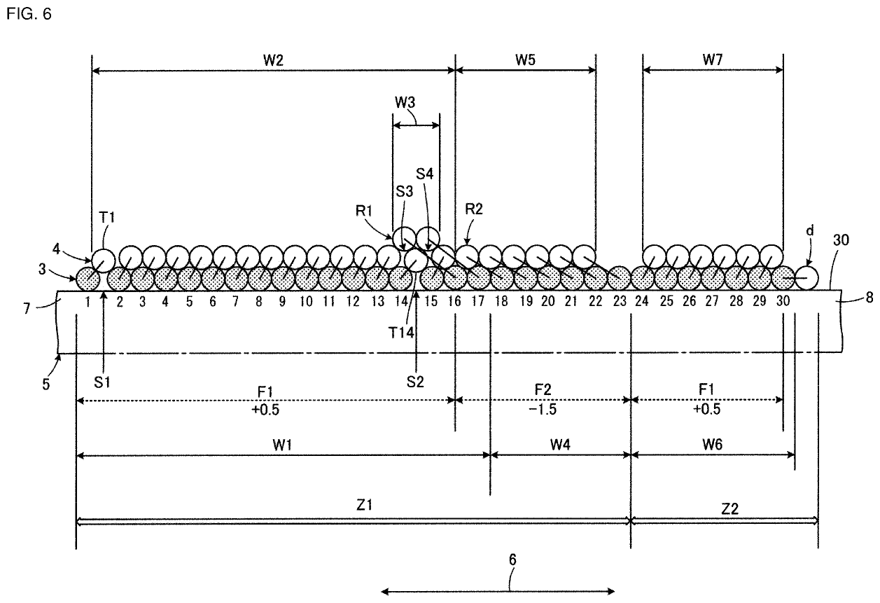

In a fourth embodiment illustrated in FIG. 6, a first wire 3 and a second wire 4 are wound in a first winding area Z1 and a second winding area Z2 that are arranged in the axis direction 6 of the winding core portion 5 and whose winding modes differ from each other.

The first winding area Z1 includes (1-1) a first winding portion W1 (turns T1 to T17) in which the first wire 3 is wound in the first layer in the direction from the first end portion 7 to the second end portion 8, (1-2) a second winding portion W2 (turns T1 to T15) in which the second wire 4 is wound in the second layer in the direction from the first end portion 7 to the second end portion 8, (1-3) a first transfer portion R1 (from turn T15 to turn T16) in which the direction of the second wire 4 is changed at the end portion of the second winding portion W2 on the second end portion 8 side to the direction to the first end portion 7, and the second wire 4 is lead to a position in the third layer, (1-4) a third winding portion W3 (turns T16 and T17) in which the second wire 4 continuous with the first transfer portion R1 is wound in the third layer, (1-5) a second transfer portion R2 (from turn T17 to turn T18) in which the second wire 4 is lead from the third winding portion W3 to a position in the second layer, (1-6) a fourth winding portion W4 (turns T18 to T23) in which the first wire 3 is wound in the first layer in the direction from the first end portion 7 to the second end portion 8, and (1-7) a fifth winding portion W5 (turns T18 to T23) in which the second wire 4 continuous with the second transfer portion R2 is wound in the second layer in the direction from the first end portion 7 to the second end portion 8.

The second winding area Z2 includes (2-1) a sixth winding portion W6 (turns T24 to T30) in which the first wire 3 is wound in the first layer in the direction from the first end portion 7 to the second end portion 8, (2-2) a seventh winding portion W7 (turns T24 to T29) in which the second wire 4 is wound in the second layer in the direction from the first end portion 7 to the second end portion 8, and (2-3) an intentional step-down portion d (turn T30) in which the second wire 4 is wound in the first layer on the second end portion 8 side of the sixth winding portion W6.

The first winding area Z1 includes a +0.5-turn difference area F1 having a positional difference of 0.5 turns in the positive direction between the first wire 3 and the second wire 4 and a −1.5-turn difference area F2 having a positional difference of 1.5 turns in the negative direction between the first wire 3 and the second wire 4.

The second winding area Z2 includes a +0.5-turn difference area F1 having a positional difference of 0.5 turns in the positive direction between the first wire 3 and the second wire 4.

This configuration reduces the influence of the stray capacitance between the first wire 3 and the second wire 4 and, for example, reduces the level of the mode conversion characteristics in the case of a common-mode choke coil.

The turns of the second wire 4 include non-contact turns T1 and T14 with which any wire is not in contact at least from the first end portion 7 side. A gap S1 is formed between turns T1 and T2 of the first wire 3 forming the recess into which the non-contact turn T1 of the second wire 4 is fitted, and a gap S2 is formed between turns T14 and T15 of the first wire 3 forming the recess into which the non-contact turn T14 of the second wire 4 is fitted.

Also in this embodiment, the gaps S1 and S2 have a size L defined by ⅕×D≤L ≤(√3−1) ×D when measured in the axis direction 6.

Since turn T14 of the second wire 4 is fitted between turns T14 and T15 of the first wire 3 forming the gap S2 described above, it is natural that the gaps S3 and S4 are formed on either side of turn T14 of the second wire 4. Since turns T16 and T17 of the second wire 4 located in the third layer described above are fitted into the gaps S3 and S4, respectively, and are thus less likely to have a positional deviation. The gaps S3 and S4 are a little narrower than the gaps S1 and S2.

In the fourth embodiment described above, the number of turns of the second wire 4 located in the third layer is different from that of the third embodiment described earlier. As can be seen from this, the number of turns of a wire located in the third layer can be changed to any number as necessary.

### Fifth Embodiment

In a fifth embodiment illustrated in FIG. 7, a first wire 3 and a second wire 4 are wound in a first winding area Z1, a second winding area Z2, and a third winding area Z3 that are arranged in the axis direction 6 of the winding core portion 5 and whose winding modes differ from one another.

The first winding area Z1 includes (1-1) a first winding portion W1 (turns T1 to T19) in which the first wire 3 is wound in the first layer in the direction from the first end portion 7 to the second end portion 8, (1-2) a second winding portion W2 (turns T1 to T5) in which the second wire 4 is wound in the second layer in the direction from the first end portion 7 to the second end portion 8, (1-3) a first transfer portion R1 (from turn T5 to turn T6) in which the direction of the second wire 4 is changed at the end portion of the second winding portion W2 on the second end portion 8 side to the direction to the first end portion 7, and the second wire 4 is lead to a position in the third layer, (1-4) a third winding portion W3 (turn 16) in which the second wire 4 continuous with the first transfer portion R1 is wound in the third layer, (1-5) a second transfer portion R2 (from turn T6 to turn T7) in which the second wire 4 is lead from the third winding portion W3 to a position in the second layer, and (1-6) a fourth winding portion W4 (turns T7 to T9) in which the second wire 4 continuous with the second transfer portion R2 is wound in the second layer.

The second winding area Z2 includes (2-1) a fifth winding portion W5 (turns T10 to T19) in which the first wire 3 is wound in the first layer in the direction from the first end portion 7 to the second end portion 8, (2-2) a sixth winding portion W6 (turns T10 to T15) in which the second wire 4 is wound in the second layer in the direction from the first end portion 7 to the second end portion 8, (2-3) a third transfer portion R3 (from turn T15 to turn T16) in which the direction of the second wire 4 is changed at the end portion of the sixth winding portion W6 on the second end portion 8 side to the direction to the first end portion 7, and the second wire 4 is lead to a position in the third layer, (2-4) a seventh winding portion W7 (turns T16 and T17) in which the second wire 4 continuous with the third transfer portion R3 is wound in the third layer, (2-5) a fourth transfer portion R4 (from turn T17 to turn T18) in which the second wire 4 is lead from the seventh winding portion W7 to a position in the second layer, and (2-6) an eighth winding portion W8 (turns T18 and T19) in which the second wire 4 continuous with the fourth transfer portion R4 is wound in the second layer in the direction from the first end portion 7 to the second end portion 8.

The third winding area Z3 includes (3-1) a ninth winding portion W9 (turns T20 to T28) in which the first wire 3 is wound in the first layer in the direction from the first end portion 7 to the second end portion 8, (3-2) a tenth winding portion W10 (turns T20 to T24) in which the second wire 4 is wound in the second layer in the direction from the first end portion 7 to the second end portion 8, (3-3) a fifth transfer portion R5 (from turn T24 to turn T25) in which the direction of the second wire 4 is changed at the end portion of the tenth winding portion W10 on the second end portion 8 side to the direction to the first end portion 7, and the second wire 4 is lead to a position in the third layer, (3-4) an eleventh winding portion W11 (turn T25) in which the second wire 4 continuous with the fifth transfer portion R5 is wound in the third layer, (3-5) a sixth transfer portion R6 (from turn T25 to turn T26) in which the second wire 4 is lead from the eleventh winding portion W11 to a position in the second layer, and (3-6) a twelfth winding portion W12 (turns T26 to T28) in which the second wire 4 continuous with the sixth transfer portion R6 is wound in the second layer in the direction from the first end portion 7 to the second end portion 8.

The first winding area Z1 includes a +0.5-turn difference area F1 having a positional difference of 0.5 turns in the positive direction between the first wire 3 and the second wire 4 and a −0.5-turn difference area F3 having a positional difference of 0.5 turns in the negative direction between the first wire 3 and the second wire 4.

The second winding area Z2 includes a +0.5-turn difference area F1 having a positional difference of 0.5 turns in the positive direction between the first wire 3 and the second wire 4 and a −1.5-turn difference area F2 having a positional difference of 1.5 turns in the negative direction between the first wire 3 and the second wire 4.

The third winding area Z3 includes a +0.5-turn difference area F1 having a positional difference of 0.5 turns in the positive direction between the first wire 3 and the second wire 4 and a −0.5-turn difference area F3 having a positional difference of 0.5 turns in the negative direction between the first wire 3 and the second wire 4.

This configuration reduces the influence of the stray capacitance between the first wire 3 and the second wire 4 and, for example, reduces the level of the mode conversion characteristics in the case of a common-mode choke coil.

The turns of the second wire 4 include non-contact turns T1, T5, T10, T14, T20, and T24 with which any wire is not in contact at least from the first end portion 7 side.

A gap S1 is formed between turns T1 and T2 of the first wire 3 forming the recess into which the non-contact turn T1 of the second wire 4 is fitted.

A gap S2 is formed between turns T5 and T6 of the first wire 3 forming the recess into which the non-contact turn T5 of the second wire 4 is fitted.

A gap S3 is formed between turns T10 and T11 of the first wire 3 forming the recess into which the non-contact turn T10 of the second wire 4 is fitted.

A gap S4 is formed in between turns T14 and T15 of the first wire 3 forming the recess into which the non-contact turn T14 of the second wire 4 is fitted.

A gap S5 is formed in between turns T20 and T21 of the first wire 3 forming the recess into which the non-contact turn T20 of the second wire 4 is fitted.

A gap S6 is formed between turns T24 and T25 of the first wire 3 forming the recess into which the non-contact turn T24 of the second wire 4 is fitted.

Also in this embodiment, the gaps S1 to S6 have a size L defined by ⅕×D≤L ≤(√3−1) ×D when measured in the axis direction 6.

The gaps S1 to S6 formed in the first layer as described above naturally form gaps in the second layer at the corresponding positions. Turns T6, T16, T17, and T25 of the second wire 4 located in the third layer are fitted into the gaps S7, S8, S9, and S10, respectively, formed naturally in the second layer and are thus less likely to have a positional deviation. These gaps S7 to S10 are a little narrower than the gaps S1 and S2.

In the fifth embodiment described above, the number of turns of the second wire 4 located in the third layer is not the same between the plurality of winding areas Z1 to Z3. As can be seen from this, the number of turns of a wire located in the third layer may differ in each winding area.

In the third to fifth embodiments of the first to fifth embodiments described above, the gaps with a size of L defined by ⅕×D≤L≤(√3−1) ×D are largest of a plurality of gaps between turns of the wire located in the first layer.

In the third to fifth embodiments, adjacent turns of the plurality of turns of the wire located in the first layer are in contact with each other, except pairs of adjacent turns forming a gap with a size of L defined by ⅕×D≤L≤(√3−1) ×D.

In the third to fifth embodiments, a second gap is formed between each non-contact turn in the second layer and each of the turns adjacent to the non-contact turn on the first end portion side and the second end portion side.

Note that all of the non-contact turns of the wire located in the second layer do not have to be fitted into turns of the wire located in the first layer, the turns forming a gap having a size of L defined by ⅕×D≤L≤(√3−1) ×D.

Although in the illustrated embodiments, the first wire 3 is wound in the first layer, and most of the second wire 4 is wound in the second layer, the first wire 3 and the second wire 4 may be interchanged in the plurality of winding areas arranged in the axis direction 6 of the winding core portion 5.

Although the present disclosure has been described based on embodiments of coil components serving as a common-mode choke coil, the present disclosure is applicable to other components such as wire-wound chip transformers.

The illustrated embodiments are mere examples, and the constituents may be partially replaced or combined between different embodiments.

The present disclosure has the following implementation configurations.
<1> A coil component including a core including a winding core portion having a first end portion and a second end portion opposed to each other in an axis direction of the winding core portion; and a first wire and a second wire having a circular cross section with a diameter of D and spirally wound around the winding core portion in a direction from the first end portion to the second end portion to have substantially the same number of turns. One of the first wire and the second wire includes a portion wound to form a first layer which is a layer closest to a peripheral surface of the winding core portion, the other of the first wire and the second wire includes a portion wound to be fitted into recesses formed between adjacent turns of a wire or wires located in the first layer and to form a second layer which is a layer of turns on an outer peripheral side of the first layer. Regarding positional relationship between turns of the wire located in the first layer and turns of a wire located in the second layer, when it is assumed that if a certain turn of the wire located in the second layer and having a number counted from the first end portion is located on a second end portion side of a turn of the wire located in the first layer and having the same number counted from the first end portion as the certain turn, a direction of a positional difference is defined as a positive direction, and if in an opposite case, a direction of a positional difference is defined as a negative direction, the coil component includes a positive-direction positional difference area having a positional difference in the positive direction between turns of the first wire and the second wire and a negative-direction positional difference area having a positional difference in the negative direction between turns of the first wire and the second wire, and the turns of the wire located in the second layer include non-contact turns with which any wire located in the second layer is not in contact at least from a first end portion side. A gap between two adjacent turns of the wire or the wires located in the first layer and forming a recess into which at least one of the non-contact turns is fitted has a size of L defined by ⅕×D≤L≤(√3−1) ×D when measured in the axis direction.
<2> The coil component according to <1>, in which of gaps between a plurality of turns of the wire or the wires located in the first layer, the gap having a size of L is largest.
<3> The coil component according to <2>, in which the turns of the wire or the wires located in the first layer are in contact with each other between adjacent turns, except between the two adjacent turns forming the gap with a size of L.
<4> The coil component according to any one of <1> to <3>, in which the non-contact turn fitted between the two turns having the gap with a size of L is closest to the first end portion, of the turns of the wire located in the second layer.
<5> The coil component according to any one of <1> to <4>, in which the first wire and the second wire are wound in a plurality of winding areas that are arranged in the axis direction of the winding core portion and whose winding modes differ from one another. Also, the non-contact turn fitted between the two turns having the gap with a size of L is closest to the first end portion in each of the winding areas, of the turns of the wire located in the second layer.
<6> The coil component according to any one of <1> to <5>, in which the two adjacent turns of the wire located in the first layer and forming the recess into which the non-contact turn is fitted are formed by one of the first wire and the second wire.
<7> The coil component according to any one of <1> to <5>, in which one of the two adjacent turns of the wires located in the first layer and forming the recess into which the non-contact turn is fitted is formed by the first wire and the other of the two adjacent turns is formed by the second wire.
<8> The coil component according to any one of <1> to <7>, in which in the second layer, a second gap is formed between the non-contact turn and each of turns located adjacent to the non-contact turn on the first end portion side and the second end portion side.
<9> The coil component according to <8>, in which one of the first wire and the second wire includes a portion wound to be fitted into a second recess formed between adjacent turns of the wire located in the second layer and to form a third layer, which is a layer of turns on the outer peripheral side of the second layer, in part of a winding range of the wire located in the second layer. Also, at least one turn of the wire located in the third layer is fitted into the second gap.

What is claimed is:

1. A coil component comprising:
a core including a winding core portion having a first end portion and a second end portion opposed to each other in an axis direction of the winding core portion; and
a first wire and a second wire having a circular cross section with a diameter of D and spirally wound around the winding core portion in a direction from the first end portion to the second end portion to have substantially a same number of turns, wherein
one of the first wire and the second wire includes a portion wound to configure a first layer closest to a peripheral surface of the winding core portion,
the other of the first wire and the second wire includes a portion wound to configure a second layer wound on an outer peripheral side of the first layer while being in recesses between adjacent turns of a wire in the first layer,
regarding positional relationship between turns of the wire in the first layer and turns of a wire in the second layer,
a positional difference in a positive direction is defined in a positive direction case where a turn of the wire in the second layer having a certain turn number counted from the first end portion is closer to a second end portion side than a turn of the wire in the first layer having a same turn number as the turn of the wire in the second layer, and
a positional difference in a negative direction is defined in a negative direction case which is opposite to the positive direction case, such that in the negative direction case a turn of the wire in the second layer having a certain turn number counted from the first end portion is further from a second end portion side than a turn of the wire in the first layer having a same turn number as the turn of the wire in the second layer,
the coil component includes a positive-direction positional difference area having a positional difference in the positive direction between turns of the first wire and the second wire and a negative-direction positional difference area having a positional difference in the negative direction between turns of the first wire and the second wire, and
the turns of the wire in the second layer include non-contact turns in the second layer which are not in contact with any other wire in the second layer at least at a first end portion side, and
a gap is between two adjacent turns of the wire in the first layer and defines a recess into which at least one of the non-contact turns in the second layer is present,
the gap has a size of L defined by an expression when measured in the axis direction:
⅕×D≤L≤(√3−1)×D.

2. The coil component according to claim 1, wherein
the gap having the size of L is largest of gaps between a plurality of turns of the wire in the first layer.

3. The coil component according to claim 2, wherein
the turns of the wire in the first layer are in contact with each other between adjacent turns, except between the two adjacent turns defining the gap having the size of L.

4. The coil component according to claim 1, wherein
the non-contact turn in the second layer which is between the two turns having the gap with the size of L in the first layer is closest to the first end portion side of the turns of the wire in the second layer.

5. The coil component according to claim 1, wherein
the first wire and the second wire are wound in a plurality of winding areas that are in the axis direction of the winding core portion and whose winding modes differ from one another, and
the non-contact turn in the second layer which is between the two turns having the gap with the size of L in the first layer is closest to the first end portion side in each of the winding areas of the turns of the wire in the second layer.

6. The coil component according to claim 1, wherein
the two adjacent turns of the wire in the first layer and defining the recess into which the non-contact turn is present are configured by one of the first wire and the second wire.

7. The coil component according to claim 1, wherein
one of the two adjacent turns of the wires in the first layer and defining the recess into which the non-contact turn is present is configured by the first wire, and
the other of the two adjacent turns of the wires in the first layer is configured by the second wire.

8. The coil component according to claim 1, wherein
in the second layer, second gaps are defined between the non-contact turn and each of turns adjacent to the non-contact turn on the first end portion side and the second end portion side.

9. The coil component according to claim 8, wherein
one of the first wire and the second wire includes a portion wound to configure a third layer on an outer peripheral side of the second layer while being in a second recess between adjacent turns of the wire in the second layer, in part of a winding range of the wire in the second layer, and
at least one turn of the wire in the third layer is in the second gap.

10. The coil component according to claim 2, wherein
in the second layer, second gaps are defined between the non-contact turn and each of turns adjacent to the non-contact turn on the first end portion side and the second end portion side.

11. The coil component according to claim 3, wherein
in the second layer, second gaps are defined between the non-contact turn and each of turns adjacent to the non-contact turn on the first end portion side and the second end portion side.

12. The coil component according to claim 4, wherein
in the second layer, second gaps are defined between the non-contact turn and each of turns adjacent to the non-contact turn on the first end portion side and the second end portion side.

13. The coil component according to claim 5, wherein
in the second layer, second gaps are defined between the non-contact turn and each of turns adjacent to the non-contact turn on the first end portion side and the second end portion side.

14. The coil component according to claim 6, wherein
in the second layer, second gaps are defined between the non-contact turn and each of turns adjacent to the non-contact turn on the first end portion side and the second end portion side.

15. The coil component according to claim 7, wherein
in the second layer, second gaps are defined between the non-contact turn and each of turns adjacent to the non-contact turn on the first end portion side and the second end portion side.

16. The coil component according to claim 10, wherein
one of the first wire and the second wire includes a portion wound to configure a third layer on an outer peripheral side of the second layer while being in a second recess between adjacent turns of the wire in the second layer, in part of a winding range of the wire in the second layer, and
at least one turn of the wire in the third layer is in the second gap.

17. The coil component according to claim 11, wherein
one of the first wire and the second wire includes a portion wound to configure a third layer on an outer peripheral side of the second layer while being in a second recess between adjacent turns of the wire in the second layer, in part of a winding range of the wire in the second layer, and
at least one turn of the wire in the third layer is in the second gap.

18. The coil component according to claim 11, wherein
one of the first wire and the second wire includes a portion wound to configure a third layer on an outer peripheral side of the second layer while being in a second recess between adjacent turns of the wire in the second layer, in part of a winding range of the wire in the second layer, and
at least one turn of the wire in the third layer is in the second gap.

19. The coil component according to claim 12, wherein
one of the first wire and the second wire includes a portion wound to configure a third layer on an outer peripheral side of the second layer while being in a second recess between adjacent turns of the wire in the second layer, in part of a winding range of the wire in the second layer, and
at least one turn of the wire in the third layer is in the second gap.

20. The coil component according to claim 13, wherein
one of the first wire and the second wire includes a portion wound to configure a third layer on an outer peripheral side of the second layer while being in a second recess between adjacent turns of the wire in the second layer, in part of a winding range of the wire in the second layer, and
at least one turn of the wire in the third layer is in the second gap.
